(19) United States
(12) Patent Application Publication
(10) Pub. No.: US 2018/0339660 A1
(43) Pub. Date: Nov. 29, 2018

(54) PORTFOLIO WORK STATION

(71) Applicant: The Gem Group, Inc., Lawrence, MA (US)

(72) Inventors: Calvin Tabor, Westford, MA (US); Richard C. Bellofatto, JR., Peabody, MA (US)

(21) Appl. No.: 15/988,422

(22) Filed: May 24, 2018

Related U.S. Application Data
(60) Provisional application No. 62/510,714, filed on May 24, 2017.

(51) Int. Cl. B60R 7/04; A45C 13/02; A45C 13/10

(52) U.S. Cl. CPC B60R 7/043; B60N 3/002; A45C 13/10; A45C 13/02

(57) ABSTRACT

A portfolio work station can be comprised of a first lid including a panel covered by a non-slip treatment; at least one of a side strap; a hinge; and a second lid including an adjustable mounting strap assembly. The adjustable mounting strap assembly can be extended to stabilize the portfolio work station in a vehicle seat. The non-slip treatment can be an arrestor array. The arrestor array can provide support to the bottom of a propped electronic device. The side strap can be adjustable and can be adjusted to maintain the stability of the portfolio work station. The arrestor array can be comprised of a plurality of arrestors. Each of a plurality of arrestors can be comprised of arrestor strips arranged in a pattern. The arrangement of the arrestor strips can be an open “X” pattern.

### RELATED APPLICATION

This application claims the benefit of co-pending U.S. Provisional Application Ser. No. 62/510,714, entitled PORTFOLIO WORK STATION, filed May 24, 2017, the teachings of which are expressly incorporated herein by reference.

### FIELD OF THE INVENTION

The present invention relates to the field of briefcases, and in particular, to briefcases that can be converted to a work station

### BACKGROUND OF THE INVENTION

The modern office can be either a fixed or mobile location. The progress of communications provides opportunities for workers to conduct business from alternate locations. A work station can include a stable platform for an electronic processing device (for example, a tablet, laptop computer or other communication device), with a place for business cards, keys, writing instruments, files and the other impedimenta of a desk. Tablets and laptops can be placed in a work station, sometimes propped up to a desired position. All of this can be reduced in size and made to fit within a single briefcase, or business portfolio. One of the disadvantages of using a mobile work station is its stability as a platform for work and supporting an electronic device. It is a common problem for an unstable platform to tip over or slide away, or be too slippery to sustain a propped tablet during use.

A conventional briefcase is not an effective portable work station by virtue of its construction. For example, while the hinges are designed to easily close and can be locked open, they can be easily knocked out of the locked position. The interior of the briefcase is a well with surrounding walls and a floor that is smooth of comprised of one of more divider panels, covered with a smooth material, and without interior support for any propped electronic tablets. This is exacerbated when the user is within a moving vehicle (for example, a car, a bus, a train, a boat or an aircraft). The desire for stability is more than just about stability itself; it can be related to maintaining privacy during working time. Spilling paper work or dumping electronic devices can invite the attention of others in the vicinity.

It would be desirable to provide a work station that is stabilized, with a working surface that can accommodate propped electronic devices without letting them slip away.

### SUMMARY OF THE INVENTION

The present invention overcomes the disadvantages of the prior art by providing a stable mobile work station that provides a non-slip surface for propped electronic device. A portfolio work station can be comprised of a first lid including a panel covered by a non-slip treatment; a hinge; and a second lid including an adjustable mounting strap assembly. The adjustable mounting strap assembly can be extended to stabilize the portfolio work station in a vehicle seat. The non-slip treatment can provide support to the bottom of a propped electronic device. The side strap can be adjustable and can be adjusted to maintain the stability of the portfolio work station. The non-slip treatment can have an arrestor array. The arrestor array can have a plurality of arrestors. Each of a plurality of arrestor material elements can have arrestor strips arranged in a pattern. The arrangement of the arrestor strips can be an open “X” pattern. The interior surface of the second lid can include a plurality of pockets for receiving business accessories. Illustratively, the interior surface of the second lid includes a pocket adapted to receive a laptop computer or tablet computer behind the plurality of pockets. The panel can define a cover of a pocket located with respect to an interior surface of the first lid. Also, the first lid and the second lid can be selectively secured together with a zipper closure.

### BRIEF DESCRIPTION OF THE DRAWINGS

The invention description below refers to the accompanying drawings, of which:

FIG. 1 is perspective view of a portfolio work station in an open configuration, according to an illustrative embodiment;

FIG. 2 is a front view of the portfolio work station in a closed configuration, according to the illustrative embodiment;

FIG. 3 is a rear view of the portfolio work station in a closed configuration, according to the illustrative embodiment;

FIG. 4 is a view of the interior face of a first lid of the portfolio work station in an open configuration, according to the illustrative embodiment;

FIG. 5 is a view of the interior face of a second lid of the portfolio work station in an open configuration, according to the illustrative embodiment; and

FIG. 6 is a view of a portfolio work station, according to an alternate embodiment.

### DETAILED DESCRIPTION

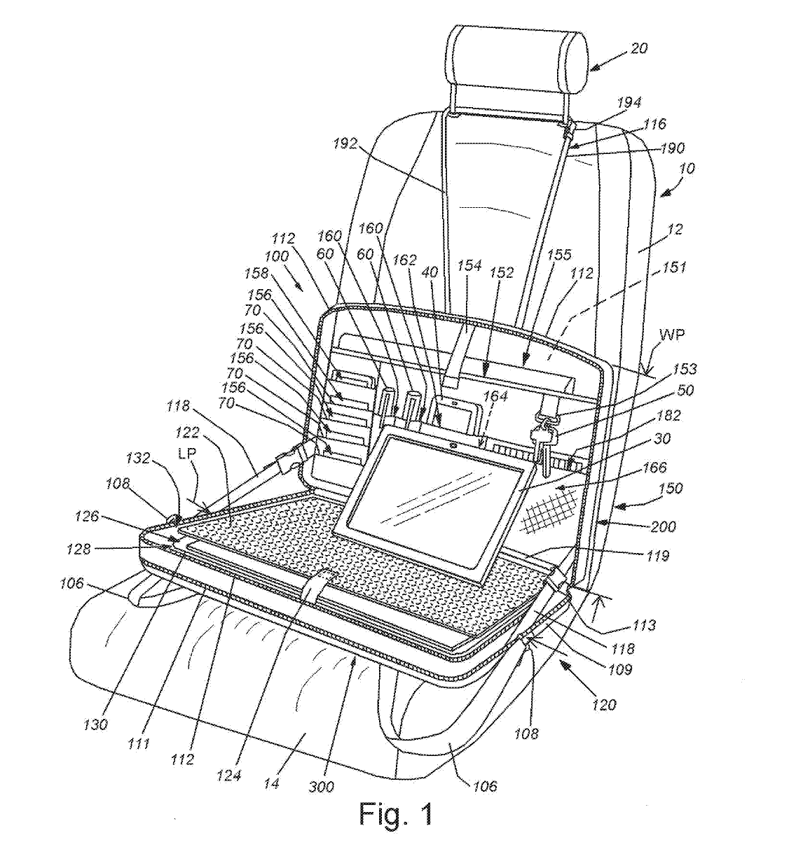

A portfolio work station 100 can be presented in one of two configurations, a closed configuration and an open configuration. In the closed configuration, a first lid 120 is engaged with a second lid 150 and the contents can reside securely within the portfolio work station 100 and can be largely unavailable to the user. In an open configuration, the first lid 120 is disengaged with the second lid 150 and the interior of the portfolio work station 100 is exposed, and the contents are accessible. A portfolio work station 100 in an open configuration is shown in FIG. 1, according to an illustrative embodiment. The illustrative portfolio work station can have a length LP of approximately 16 inches (±2 inches) and a width WP of approximately 12 inches (±2 inches). The portfolio work station can be opened so that the first lid 120 and the second lid 150 lie flat and are coplanar. In the open configuration, the portfolio work station 100 can be placed onto a vehicle seat 10. The vehicle containing the exemplary seat can be an automobile, a bus, a train car, a ship or an aircraft. In an embodiment, the seat has a back 12, a bottom 14 and a head rest 20. A mounting strap assembly 116 can be connected to the second lid 150, and can be extended to encompass the headrest 20 so as to secure the second lid 150 in a vertical state and/or secure the second lid 150 against the seat back 12. The mounting strap assembly can include a strap that is comprised of a first segment 190 and a second segment 192, and can be closed by a buckle mechanism 194. The mounting strap assembly 116 can be adjustable and the length can be varied as desired. If a head rest is not present, the mounting strap assembly 116 can be attached to another support, for example, a shoulder belt coupler, an overhead strap, or the like. It should be noted that one or more carrying handles 167 can be attached to each of the first and/or second lid and are out of view in FIG. 1.

The first lid 120 can rest on the bottom 14 of the seat. The portfolio work station 100 can include at least one side strap 118. In an embodiment, a counterpoised set of side straps 118 are each adjustable and can be adjusted such that the bottom lid rests on the seat bottom 14. The adjustable mounting strap assembly 116 can be extended around the seat back 12, headrest 20, or other mooring point, to stabilize the portfolio work station 100 in a vehicle seat 14. The side straps 118 can provide a further connection between the first lid and the second lid to provide additional stability in the open configuration. The side straps 118 can be adjustable and can be adjusted to maintain the stability of the portfolio work station. When the back 12 of the seat is reclined, the straps can be lengthened to maintain the contact between the bottom 14 and the first lid 120, and shortened when the back 12 is moved forward. The first lid 120 and the second lid 150 are joined by a flexible hinge 119 that can be one of more layers of stitched material that joins the lids and allows rotation of each lid relative to each other for an angular range of movement up to 360 degrees.

The portfolio work station 100 in the open configuration provides access to the contents of the portfolio, for example, when the second lid 150 is raised and secured to the seat back 12 by the mounting strap assembly 116. In that configuration, a tablet 30 can be placed onto the first lid 120 and rested against the second lid 150 so that it is propped in an upright position and readable by a user. The tablet 30 can be any personal computer, reader, android, or like device.

The first lid 120 can include the back portion of the portfolio work station and can be the bottom half of the work station when opened. A shoulder strap 106 can be attached to the first lid 120 at a set of mounting points 108 that can be arranged on each side of the first lid. A side pocket 109 can be located at one side of the first lid 120. In another embodiment, a side pocket can be constructed on each side of the first lid. The side pocket 109 can be accessible at a zipper closure 113. A zipper closure 111 can be located on the first lid and can enclose a first lid pocket that can be divided into smaller internal pockets. A zipper closure 112 can engage the first lid 120 and second lid 150 when the portfolio work station 100 is in the closed configuration. The first lid 120 walled by an outer surface material and lined with an interior surface material. The first lid in an open configuration can define a well 132. A panel 122 covered with a non-slip surface treatment can be the first layer of material in the well 132 and can support the tablet 30. The construction of the non-slip treatment will be described more fully below. Panel 122 can be secured by a locking strap 124.

Panel 122 can be the outer wall of a pocket 126 that can be separated from another pocket 128 by an inner wall 130. The sides of the pockets 126, 128 can be covered by folded material that creates an accordion geometry that allows each pocket to be filled and to expand outwards, towards the top of the well 132. The outer wall of pocket 128 can be the inner surface of the outer material 300 of the first lid 120. Pockets 126 and 128 can be elongated pockets having an interior volume that can be filled with paper files, magazines, a laptop computer, a portable printer, power cords or similar work station related materials. In alternate embodiments, various arrangements and numbers of pockets can be located under non-slip panel 122, including no pockets.

The second lid 150 can include a pocket for a tablet and/or numerous smaller pockets for various work station and personal effects and/or business accesories. The second lid can include a reinforcing panel 151 that can be a layer between the exterior surface material 200 of the second lid and the interior surface 155. In an embodiment, the reinforcing panel 151 can be constructed of a cardboard material, a plastic or a metal panel, or other reinforcing material. The reinforcing panel 151 can be a protective layer that provides protection for electronic devices within the portfolio work station from impacts by dissipating force, as well as a degree of protection against impaling forces. The reinforcing panel 151 can maintain the second lid 150 as a relatively flat, coplanar structure with the first lid 120, and resists flopping and rolling of the outer perimeter of the second lid 150 by providing rigidity to the second lid 150.

The interior surface/arrangement of the second lid 150 can include a tablet pocket 152 that can be locked by a locking strap 154. Lock straps 154 and 124 are depicted in FIG. 1 as being engaged by a hook and loop fastener. In other embodiments, the fastening device can be a snap, button, hook and eye, slot and tab, or another fastener mechanism. In an embodiment, the interior surface 1550 of the second lid can more generally be adapted with various pockets, pouches and the like, to secure a variety of business accessories (e.g. credit/business cards, calculators, notepads, smartphones, tablets, etc.). At one end of the interior surface 155 of the second lid 150 can be an arrangement of a plurality of card pockets 156 that are sized and arranged to hold a standard business card or electronic card 70. In the illustrative embodiment, four card pockets 156 are shown in a vertical arrangement, one pocket above the other. It is expressly contemplated that there can be more or less than four card pockets 156. A long and narrow pocket 158 can be located behind the array of card pockets 156 and can hold a personal communication device (for example, an android phone), a note pad or similar sized object. The card pocket portion of the second lid 150 can include an internal layer consisting of a sub layer of metallic foil. The metallic foil is a conductive foil that impedes and blocks radio signals, for example, a foil composed of aluminum, at least 27 microns thick. Such foil defeats card readers and efforts to steal electronically readable information from the bank/credit cards or other cards stored within. This enhances the privacy protection to devices and cards placed within the portfolio work station. In other embodiments the layer of metallic foil can be extended to the perimeter of the portfolio as an additional layer behind the respective outer layers 200, 300 to defeat electronic scanning.

The interior arrangement of the second lid 150 can include at least one writing instrument pocket 160 for receiving and retaining at least one writing instrument 60. In the illustrative embodiment, two writing instrument pockets 160 are shown in a side-by-side orientation. It is expressly contemplated that there can be more than two pockets 160. A pocket 162 for receiving and retaining a cellular phone device 40 (for example, an android) can be arranged next to the writing instrument pockets 160. In an embodiment, the pocket can be lined with a soft material to protect the display screen from scratches. Two pockets 164 and 166 can be arranged between pocket 162 and the right side of the inner surface 155 of the second lid 150. In an embodiment, pockets 164 and 166 can be constructed with an interior wall that is formed of a mesh material, such that their contents are visible. Pocket 164 can be located on the front of pocket 162. Pocket 164 can be provided with an open top and pocket 166 can be provided with a zipper closure 182. Pockets 164 and 166 can be utilized to contain smaller objects, for example, paper clips, binder clips, a stapler, coins, memory sticks, smaller cords, ear pieces, and the like. A key holder 153 can be attached at some location along the various panels of inner surface 155 to receive and hold keys 50 or like objects. It should be noted that the material of the exterior and interior surfaces of the portfolio work station can be constructed of a synthetic material (for example, a polyester), a natural material (for example, a canvas) or a combination thereof.

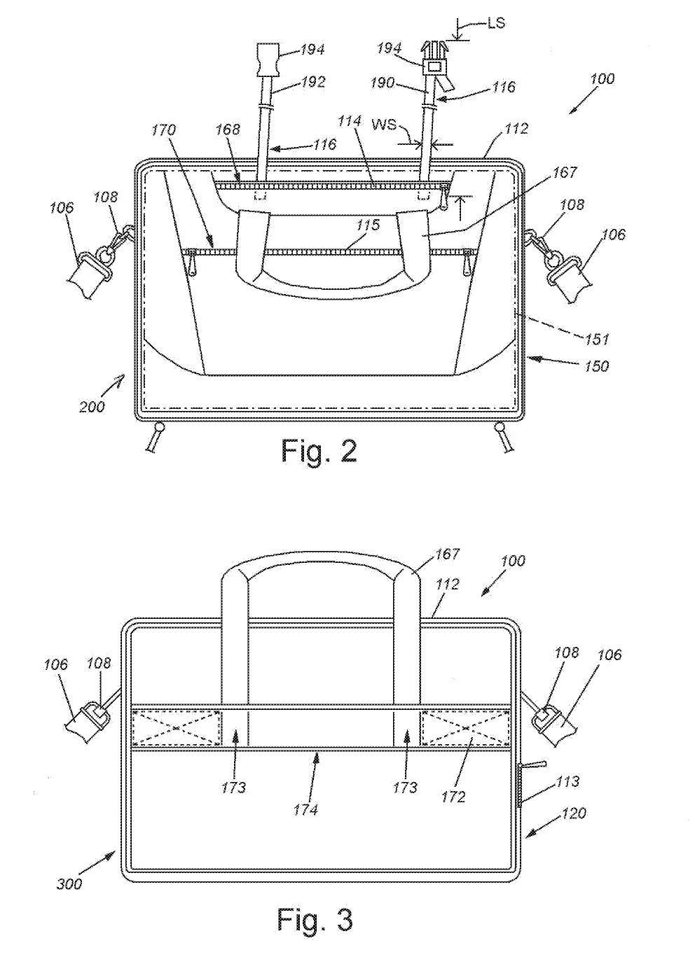

A front view of the illustrative portfolio work station 100 in a closed configuration is shown in FIG. 2. The front side can correspond to the second lid 150. The front surface 200 can include one or more pockets 168, 170 that can be closed with zipper closures 114, 115. Pocket 168 can be the anchor point and storage for the mounting strap assembly 116, including first segment 190 and a second segment 192, that can be closed by a buckle mechanism 194. Length LS of the second segment 192 can be approximately 24 inches (±2 inches) and a width WS of 0.5 inches (±0.1 inches). In an embodiment, the mounting strap assembly 116 can be constructed with nylon strap material. Handle 167 can be attached to the front surface between pockets 168 and 170. Pocket 170 can be closed by zipper closure 115. Pocket 170 can be used to receive and hold various personal articles (for example, an android).

A view of the rear side 300 of the portfolio work station 100 in a closed configuration is shown in FIG. 3. The rear side 300 can correspond to the first lid 120. Handles 167 can be provided on both the front and rear sides of the portfolio work station. The handle 167 for the rear side 300 can be secured to a luggage strap 172 at anchor points 173. The luggage strap 172 can be stitched to the surface material of the rear side 300 along its length, except for a length between the anchor points 173. This unstitched portion can be a pass-through 174 for the pulling handle of a rolling bag and facilitates attachment of the portfolio work station 100 to luggage for ease and portability for the user.

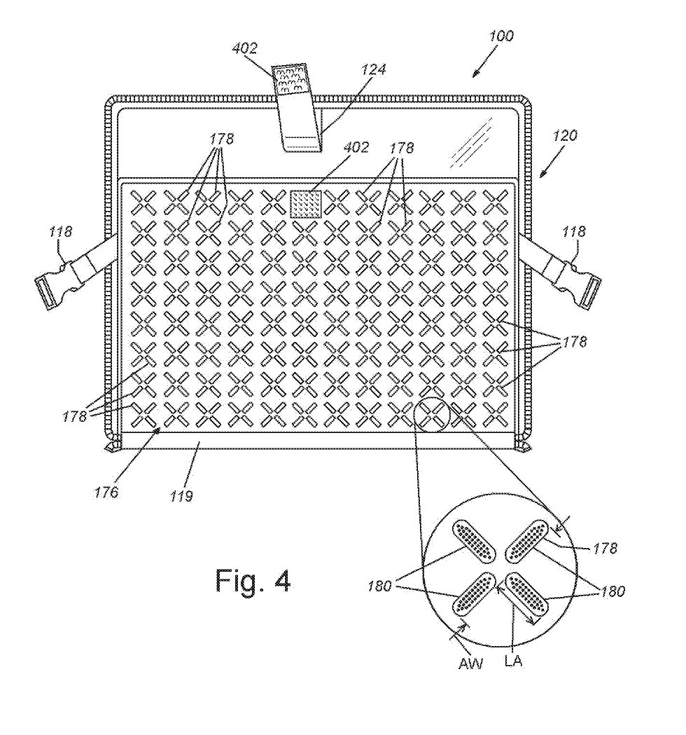

FIG. 4 is a view of the interior face of a first lid of the portfolio work station in an open configuration and shows the non-slip treatment on panel 122, according to an embodiment. Closure 402 on the locking strap 124 can be a hook and loop closure mechanism. Panel 122 can have one or more non-slip treatments. The non-slip treatment can be a rubber or other material with a coefficient of friction that can prevent objects placed on the panel 122 from sliding on the panel 122 during routine movement of a vehicle. For example, the non-slip treatment can maintain a tablet in a propped orientation, so that one edge of the tablet is held in place on the panel 122 by the non-slip treatment while the tablet is propped against the second lid 150. The non-slip treatment can maintain a laptop or other object in a fixed position on the panel during normal movement of the vehicle.

In an embodiment, panel 122 can have an arrestor array 176 arranged on the panel 122. The arrestor array can include a plurality of arrestors 178. An arrestor 178 can be comprised of arrestor strips 180 arranged in a pattern. The arrestor array 176 can an arrangement of arrestors 178, and the arrestors 178 can be patterns of strips 180. Strips 180 can have a high coefficient of friction. Strips 180 can be a soft material and together, can provide a friction for supporting the bottom of a propped tablet and can arrest it from sliding off of the panel 122 or falling down. In an embodiment, the strips 180 can be formed with rubber applied to the underlying material of the arrestor array 176. The strips 180 can be arranged to form an arrestor 178, which can be an open “X” pattern. The length LA of an individual arrestor strip 180 can be approximately 9/16 inch (+ 1/16 inch). The overall width AW of an arrestor 178 can be the distance from the outer end of a first arrestor strip to the opposite outer end of the related arrestor and can be approximately 1.5 inches (±0.2 inch). The arrestor array of FIG. 4 is depicted as regular, with the arrestors arranged in rows and columns. It is contemplated that the arrestor array can be in a random pattern or that the arrestors themselves can be arranged in a pattern other than an open “X” pattern (for example, as a five-pointed star, a circle, a hexagon, or another pattern). In some embodiments, arrestors can be arranged in lines traversing the panel 122 in one or more direction, or can be an arrangement of dots or other shapes on the panel 122. In some embodiments, the panel 122 can have a non-slip coating of a material with a high coefficient of friction. In some embodiments, the non-slip treatment can be strips or threads of rubber or another elastomeric, friction generating polymer (e.g. polyurethane, EVA, etc.), which can be woven through the panel 122. The soft and elastic/elastomeric nature of the material of the arrestors or other non-slip treatment can create a grip on the base of the tablet or other object to prevent the tablet or other object from sliding or falling down when propped. The arrestor material can be applied as one or more molded structure(s) using welding, sealing or adhesive techniques, or it can be applied by printing or spraying of a material in liquid form in a desired pattern (e.g. the Xs as illustrated or another pattern. Likewise, the entire surface of the panel, or a plurality of sections thereof can be coated or overlaid with an arrestor material.

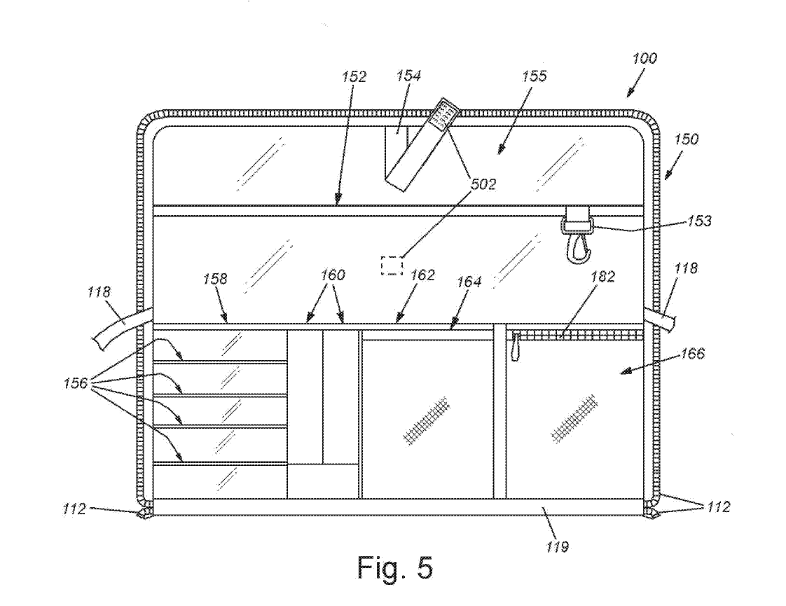

FIG. 5 is a detailed view of the interior surface 155 of a second lid 150. As noted previously, closure 502 on the locking strap 154 can be a hook and loop closure mechanism. The arrangement of the card pockets 158, writing instrument pockets 160, pockets 162 and 164 and pocket 166 can be in a sequential fashion, from left to right. It is contemplated that the ordering of such pockets can be varied, in alternate embodiments. Furthermore, it is contemplated that the lengths of said pockets can be varied, and that certain of the pockets can be omitted (for example, a writing instrument pocket 160 or pocket 166). Likewise, the key holder 153 can be placed at another location along the interior surface, and it is contemplated that two or more key holders can be provided.

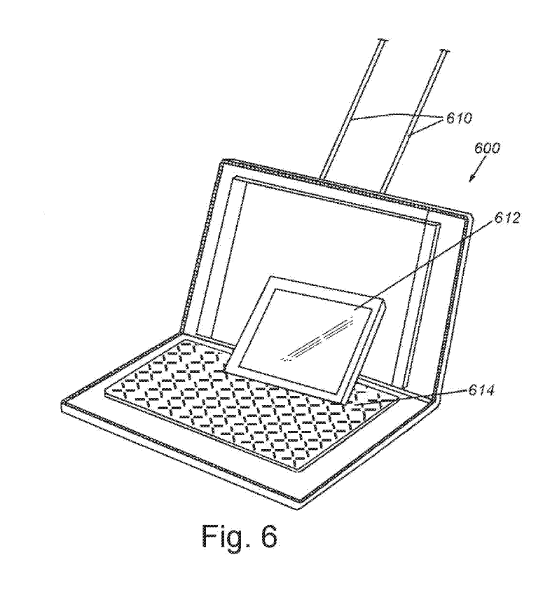

The mounting strap system, in combination with the non-slip pad can be applied to a portfolio that is smaller than a briefcase. In an alternate embodiment, a portfolio work station based on a padfolio 600, is shown in FIG. 6. A padfolio 600 can be an openable folder that can be closed by a zipper closure. The padfolio 600 can include a mounting strap assembly 610 that can be concealed within a pocket when not in use. The mounting strap assembly 610 can secure the padfolio 600 to a seat, seatback tray, or other object when in an open configuration. The mounting strap assembly 610 can be constructed in the manner of mounting strap assembly 116, as described above. A propped tablet device 612 can rest on a non-slip panel 614. Non-slip panel 614 can provide sufficient friction to prevent the propped tablet or other object from slipping or falling out of the propped position.

It should be clear to one of ordinary skill that the foregoing describes a portfolio that can be converted into a work station. The work station thus created is stable and can be secured within a vehicle. The arrestor array can support a propped electronic device for the convenience of the user. The plurality of internal pockets of varying sizes can accommodate the various effects that are part of a modern work station.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments of the apparatus and method of the present invention, what has been described herein is merely illustrative of the application of the principles of the present invention. For example, also as used herein, various directional and orientational terms (and grammatical variations thereof) such as “vertical”, “horizontal”, “up”, “down”, “bottom”, “top”, “side”, “front”, “rear”, “left”, “right”, “forward”, “rearward”, and the like, are used only as relative conventions and not as absolute orientations with respect to a fixed coordinate system, such as the acting direction of gravity. Additionally, where the term “substantially” or “approximately” is employed with respect to a given measurement, value or characteristic, it refers to a quantity that is within a normal operating range to achieve desired results, but that includes some variability due to inherent inaccuracy and error within the allowed tolerances (e.g. 1-2%) of the system. Also, various materials and arrangements of materials can be used for the non-slip treatment on the panel. Fold up panels can be located at either end of the arrestor array for greater privacy. Additional internal pockets and straps can be provided. A stiffener panel can be provided for each of the lids. The arrestor panel can be constructed so as to be detachable and removable from the work station. In further embodiments, the arrangement described above can be applied to other portfolios, including messenger bags and padfolios. Accordingly, this description is meant to be taken only by way of example, and not to otherwise limit the scope of this invention.

What is claimed is:

1. A portfolio work station comprising:
a first lid including a panel comprising a non-slip treatment;
a hinge; and
a second lid including an adjustable mounting strap assembly.

2. The portfolio work station of claim 1, wherein the adjustable mounting strap assembly can be extended to stabilize the portfolio work station in a vehicle seat.

3. The portfolio work station of claim 1, wherein the non-slip treatment provides support to the bottom of a propped electronic device.

4. The portfolio work station of claim 1, further comprising a side strap, wherein the side strap is adjustable, and is configured to be adjusted to maintain the stability of the portfolio work station.

5. The portfolio workstation of claim 1, wherein the non-slip treatment comprises an arrestor array.

6. The portfolio work station of claim 5, wherein the arrestor array is comprised of a plurality of arrestor material elements applied to the panel.

7. The portfolio work station of claim 6, wherein each of a plurality of arrestors is comprised of arrestor strips arranged in a pattern.

8. The portfolio work station of claim 7, wherein the arrangement of the arrestor strips is an open “X” pattern.

9. The portfolio as set forth in claim 1 wherein an interior surface of the second lid includes a plurality of pockets for receiving business accessories.

10. The portfolio as set forth in claim 9 wherein the interior surface of the second lid includes a pocket adapted to receive a laptop computer or tablet computer behind the plurality of pockets.

11. The portfolio as set forth in claim 1 wherein the panel can define a cover of a pocket located with respect to an interior surface of the first lid.

12. The portfolio as set forth in claim 1 wherein the first lid and the second lid are selectively secured together with a zipper closure.
